(19) United States
(12) Patent Application Publication
(10) Pub. No.: US 2014/0042135 A1
(43) Pub. Date: Feb. 13, 2014

(54) SYSTEM AND METHOD OF RECEIVING OR USING DATA FROM EXTERNAL SOURCES FOR A WELDING SEQUENCE

(71) Applicants: JOSEPH DANIEL, STREETSBORO, OH (US); MICHAEL DIDION, SHEFFIELD VILLAGE, OH (US); EDWARD ENYEDY, EASTLAKE, OH (US); DANIEL FLEMING, PAINESVILLE, OH (US); JAMES HEARN, BRUNSWICK, OH (US); JUDAH HENRY, GENEVA, OH (US)

(72) Inventors: JOSEPH DANIEL, STREETSBORO, OH (US); MICHAEL DIDION, SHEFFIELD VILLAGE, OH (US); EDWARD ENYEDY, EASTLAKE, OH (US); DANIEL FLEMING, PAINESVILLE, OH (US); JAMES HEARN, BRUNSWICK, OH (US); JUDAH HENRY, GENEVA, OH (US)

(73) Assignee: LINCOLN GLOBAL, INC., CITY OF INDUSTRY, CA (US)

(21) Appl. No.: 13/802,985

(22) Filed: Mar. 14, 2013

Related U.S. Application Data
(63) Continuation-in-part of application No. 11/613,652, filed on Dec. 20, 2006.

(51) Int. Cl. B23K 9/10

(52) U.S. Cl. CPC B23K 9/10
USPC 219/130.5

(57) ABSTRACT

The invention described herein generally pertains to a system and method for performing a welding operation that is controlled in part by a welding sequence. An input component is provided that receives an input from an operator during a performance of a welding operation in which the input allows control of the welding operation or feedback from the welding operation. In an embodiment, the input component is incorporated or affixed to equipment of the operator. An Radio Frequency Identification (RFID) tag is further utilized to control use of a welding sequence based on wireless data communicated between the RFID tag and an RFID component.

### CROSS-REFERENCE TO RELATED APPLICATIONS

This application is a continuation-in-part of U.S. application Ser. No. 11/613,652, filed Dec. 20, 2006, and entitled “WELDING JOB SEQUENCER.” The entirety of the aforementioned application is incorporated herein by reference.

### TECHNICAL FIELD

Devices, systems, and methods consistent with the invention relate to welding work cells.

### BACKGROUND OF THE INVENTION

In the related art, work cells are used to produce welds or welded parts. There are at least two broad categories of work cells, including robotic work cells and semi-automatic work cells.

In robotic work cells, the scheduling and performing of welding operations is largely automated, with little operator involvement. Thus, these cells generally have a relatively low labor cost and a relatively high productivity. However, their repeating operations cannot easily adapt to varying welding conditions and/or sequences.

In contrast, semi-automatic work cells (i.e., work cells involving at least some operator welding) generally provide less automation vis-à-vis robotic work cells, and accordingly have a relatively higher labor cost and a relatively lower productivity. Nevertheless, there are many instances where using a semi-automatic welding work cell can actually be advantageous over robotic work cells. For example, a semi-automatic welding work cell can more easily adapt to varying welding conditions and/or sequences.

Unfortunately, when welding more complex assemblies in related art semi-automatic work cells, multiple different welding schedules are often required for different types of welds on different parts of an assembly. In many systems, when a different welding schedule must be utilized, the operator is required to stop welding operations and manually adjust the output of the semi-automatic equipment according to the new schedule. In some other systems, this manual adjustment is eliminated by storing particular schedules in the work cell. Nevertheless, even in such systems, the operator still needs to cease welding operations and push a button to select the new welding schedule before he may continue welding.

Neither of these practices for setting a different welding schedule is particularly efficient. Thus, in practice, the number of welding schedules used in a semi-automatic work cell is often reduced in order to eliminate the need for constant adjustment of the output of the semi-automatic equipment. While this reduction of welding schedules makes the overall operation easier for the welder, the forced simplification of this approach can lead to reduced productivity and lower overall quality.

Additionally, when abiding by strict quality control specifications, it is sometimes necessary to perform welds in a specific sequence, verify that each weld is performed with a given set of conditions, and monitor the output of the equipment during the welding operations. In a robotic work cell, these requirements are easily fulfilled. However, in a semi-automatic work cell, these requirements are susceptible to human error, since the operator must keep track of all of these aspects in addition to performing the welding operations themselves.

An illustrative example of the above problems is shown in the related art semi-automatic welding method diagrammatically represented in FIG. 1. In this method, each of the various scheduling, sequencing, inspection and welding operations are organized and performed by the operator (i.e., the welder) himself. Specifically, the operator begins the welding job at operation 10. Then, the operator sets up the welding equipment according to schedule A, at operation 20. Next, the operator performs weld #1, weld #2, and weld #3 using welding schedule A at operations 22, 24 and 26. Then, the operator stops welding operations and sets up the welding equipment according to schedule B at operation 30. Next, the operator performs weld #4 using welding schedule B at operation 32. Then, the operator checks the dimensions of the assembly at operation 40, and sets up the welding equipment according to schedule C at operation 50. Next, the operator performs weld #5 and weld #6 using welding schedule C at operations 52 and 54. After the welding operations are completed, the operator visually inspects the welded assembly at operation 60, and completes the welding job at operation 70.

Clearly, the method shown in FIG. 1 depends on the operator to correctly follow the predefined sequencing for performing welds and inspections, to accurately change between welding schedules (such as at operation 30), and to perform the welding itself. Errors in any of these responsibilities can result either in rework (if the errors are caught during inspection at operation 60) or a defective part being supplied to the end user. Further, this exemplary semi-automatic welding method hampers productivity, because the operator must spend time configuring and reconfiguring weld schedules.

The above problems demand an improvement in the related art system.

### SUMMARY OF THE INVENTION

In accordance with an embodiment of the present invention, a welding system is provided that includes a welding job sequencer component that is configured to identify a welding sequence for a welding work cell, wherein the welding sequence defines at least a parameter and a welding schedule for a first welding procedure to create a first weld on a workpiece and a second welding procedure to create a second weld on the workpiece. The welding job sequencer component is further configured to utilize the welding sequence in the welding work cell to automatically configure welding equipment to perform the first welding procedure and the second welding procedure on the workpiece without intervention from the operator. In the embodiment, the welder system further includes an input component that is configured to receive an input from the operator while the operator is performing at least one of the first weld or the second weld, wherein the input controls at least one of the utilization of the welding sequence or the welding job sequencer component.

In accordance with an embodiment of the present invention, a method of welding in a welding work cell with a welding sequence is provided that includes at least the steps of: identifying a welding sequence for an operator to use in a welding work cell, wherein the welding sequence defines a first welding procedure that includes a first parameter to create a first weld on a workpiece and a second welding procedure that includes a second parameter to create a second weld on the workpiece; utilizing the welding sequence to automatically modify a welding equipment within the welding work cell without intervention from the operator creating at least one of the first weld or the second weld; and receiving an input from the operator while the operator is performing at least one of the first weld or the second weld with the welding sequence, wherein the input controls use of the welding sequence.

In accordance with an embodiment of the present invention, a welding system is provided that includes at least the following: means for identifying a welding sequence for an operator to use in a welding work cell, wherein the welding sequence defines a first welding procedure that includes a first parameter to create a first weld on a workpiece and a second welding procedure that includes a second parameter to create a second weld on the workpiece; means for utilizing the welding sequence to automatically modify a welding equipment within the welding work cell without intervention from the operator creating at least one of the first weld or the second weld; means for receiving an input from the operator while the operator is performing at least one of the first weld or the second weld; means for receiving a wireless signal from a Radio Frequency Identification (RFID) tag affixed to at least one of the workpiece or a fixture securing the workpiece; and means for controlling use of the welding sequence based on at least one of the wireless signal from the RFID tag or the input.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a welding operation of the related art utilizing a semi-automatic welding work cell;

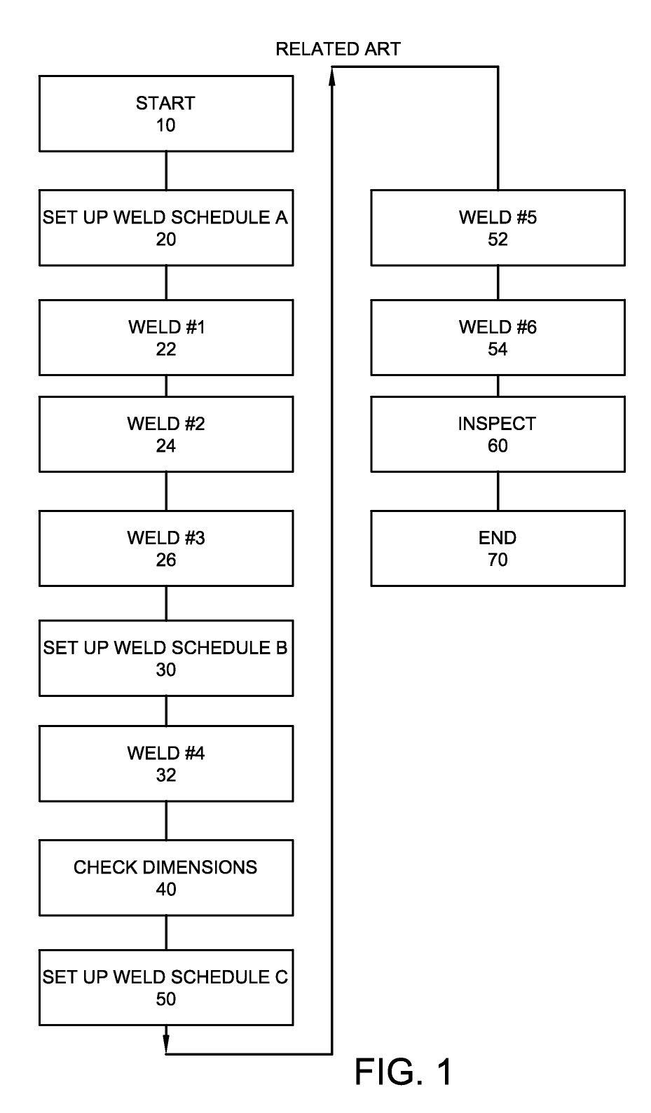

FIG. 2 illustrates a welding operation according to the invention utilizing a semi-automatic welding work cell;

FIG. 3 is a block diagram illustrating a welding system that utilizes a welding job sequencer component to configure welding equipment for two or more weld operations to assembly a workpiece;

FIG. 4 is a block diagram illustrating a welding system that utilizes a welding job sequencer component;

FIG. 5 is a block diagram illustrating a distributed welding environment with a plurality of welding work cells that interface with a welding job sequencer component via a local, remote, or cloud database;

FIG. 6 is a block diagram illustrating a welding system that includes a plurality of welding work cells in which welding work cells are managed by a cloud-based welding job sequencer component;

FIG. 7 is a block diagram illustrating a system that communicates with an operator during performance of a weld with a welding sequence;

FIG. 8 is a block diagram illustrating a system that interfaces one or more components to perform a welding procedure using a welding sequence;

FIG. 9 is a block diagram illustrating a system that uses a Radio Frequency Identification (RFID) tag to control use of a welding sequence in a welding work cell;

FIG. 10 is a block diagram illustrating a system that manages a welding sequence used for performing a weld;

FIG. 11 is a flow diagram of controlling a welding operation that uses a welding sequence in real time; and

FIG. 12 is a flow diagram of utilizing a wireless signal to control one or more welding procedures that use a welding sequence.

### DETAILED DESCRIPTION OF THE INVENTION

Embodiments of the invention relate to methods and systems that facilitate performing a welding operation that is controlled in part by a welding sequence. An input component is provided that receives an input from an operator during a performance of a welding operation in which the input allows control of the welding operation or feedback from the welding operation. In an embodiment, the input component is incorporated or affixed to equipment of the operator. In another embodiment, a portable device incorporates the input component, wherein the operator interacts with the portable device to provide the input. An Radio Frequency Identification (RFID) tag is further utilized to control use of a welding sequence based on wireless data communicated between the RFID tag and an RFID component (also referred to as an RFID component).

According to an aspect of the invention, there is provided a semi-automatic welding work cell including a welding job sequencer that automatically selects a welding schedule for use by an operator in the semi-automatic welding work cell.

According to another aspect of the invention, there is provided a method of welding in a semi-automatic work cell, including automatically selecting a welding schedule for use by an operator in the semi-automatic welding work cell.

According to another aspect of the invention, there is provided a welding production line including at least one semi-automatic welding work cell, where the semi-automatic work cell includes a welding job sequencer that automatically selects a welding schedule for use by an operator therein.

According to another aspect of the invention, there is provided a method of monitoring a welding production line, including automatically selecting a welding schedule for use by an operator in a semi-automatic welding work cell.

The term “component” as used herein can be defined as a portion of hardware, a portion of software, or a combination thereof. A portion of hardware can include at least a processor and a portion of memory, wherein the memory includes an instruction to execute.

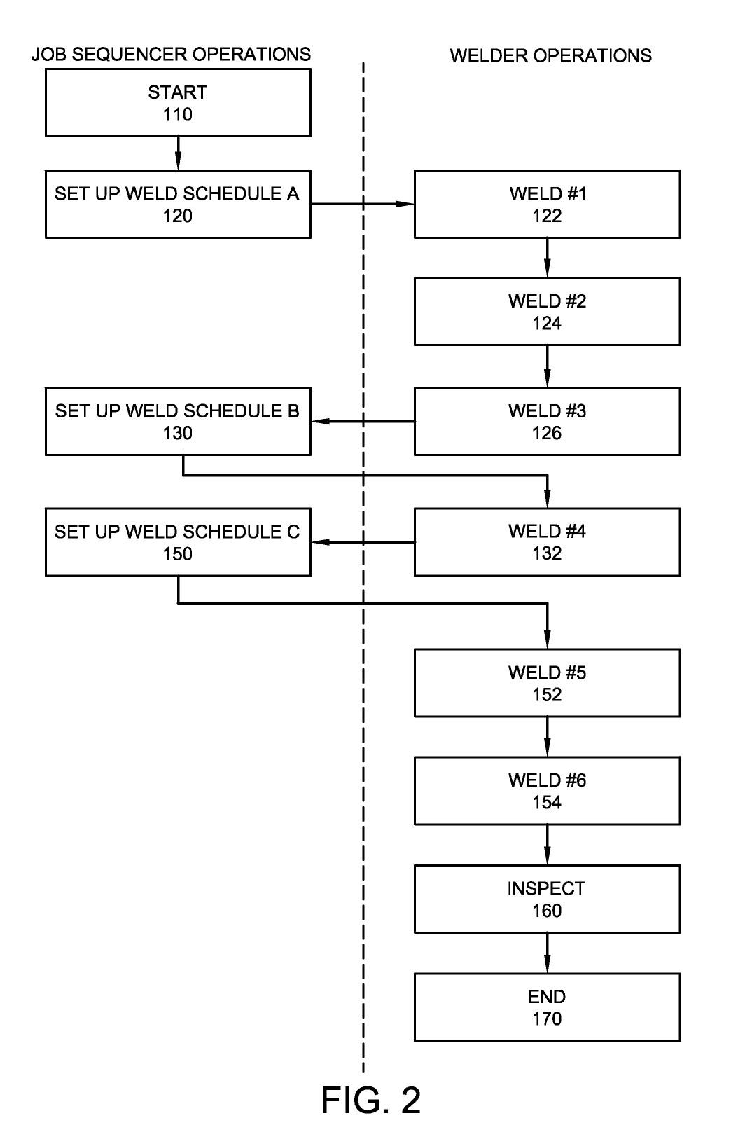

The best mode for carrying out the invention will now be described for the purposes of illustrating the best mode known to the applicant at the time of the filing of this patent application. The examples and figures are illustrative only and not meant to limit the invention, which is measured by the scope and spirit of the claims. Referring now to the drawings, wherein the showings are for the purpose of illustrating an exemplary embodiment of the invention only and not for the purpose of limiting same, FIG. 2 is referenced. In an exemplary embodiment of the invention as illustrated in FIG. 2, a welding job sequencer is provided. The welding job sequencer improves the semi-automatic work cell of the related art by increasing the productivity of the semi-automatic work cell without compromising the number of weld schedules usable therein. The welding job sequencer accomplishes this improvement by implementing automatic changes in the semi-automatic work cell, and by providing the operator with an array of commands and instructions.

More specifically, in an exemplary embodiment, the welding job sequencer automatically selects and implements a function of the welding work cell. An example of such a function includes a particular weld schedule to be used with the semi-automatic work cell. In other words, the welding job sequencer may select a weld schedule to be used for a particular weld, and modify the settings of the semi-automatic work cell in accordance with the selected weld schedule, automatically for the operator (i.e., without the operator's specific intervention).

Additionally, in the exemplary embodiment, the welding job sequencer may automatically indicate a sequence of operations that the operator should follow to create a final welded assembly. In conjunction with the automatic selection of welding schedules, this indicated sequence allows an operator to follow the sequence to create a final welded part, without having to spend time adjusting, selecting, or reviewing each individual weld schedule and/or sequence.

Accordingly, since the welding job sequencer sets up the welding equipment and organizes the workflow, and since the operator only performs the welding operations themselves, the chance for error in the welding operation is greatly reduced, and productivity and quality are improved.

The exemplary embodiment is diagrammatically represented in FIG. 2. In FIG. 2, at operation 110, the welding job sequencer begins operation, and immediately sets the welding equipment to use weld schedule A (operation 120) and instructs the operator to perform welds #1, #2 and #3. Then, the operator performs welds #1, #2 and #3 using weld schedule A (operations 122, 124 and 126). Next, the welding job sequencer sets the welding equipment to use weld schedule B (operation 130), and instructs the operator to perform weld #4. Then the operator performs weld #4 using weld schedule B (operations 132). After completion of weld schedule B, the welding job sequencer sets the welding equipment to use weld schedule C (operation 150), and instructs the operator to perform welds #5 and #6, and to inspect the part. Then, the operator performs welds #5 and #6 (operations 152, and 154) using weld schedule C, and inspects the completed part to confirm that it is correct (operation 160). This inspection may include dimensional verification, visual defect confirmation, or any other type of check that might be needed. Further, operation 160 may include a requirement that the operator affirmatively indicate that the inspection is complete, such as by pressing an “OK” button, before it is possible to proceed to the next operation. Lastly, the welding job sequencer indicates that the welding operation is at an end (operation 170), and re-sets for the next operation.

Accordingly, as noted above, the sequencing and scheduling of welding operations is completed by the sequencer, and frees the operator to focus on performing welds according to instruction.

The welding job sequencer may select and implement a new function, such as the selection and implementation of weld schedules A, B and C shown in FIG. 2, based upon various variables or inputs. For example, the welding job sequencer may simply select new weld schedules based upon a monitoring of elapsed time since the beginning of the welding operations, or since the cessation of welding (such as the time after weld #3 in FIG. 2 above). Alternatively, the welding job sequencer may monitor the actions of the operator, compare the actions to the identified sequence of welds, and select new weld schedules appropriately. Still further, various combinations of these methods, or any other effective method, may be implemented, as long as the end effect is to provide an automatic selection and implementation of a function, such as the weld schedule, for use by the operator.

Parameters of the selected weld schedule may include such variables as welding process, wire type, wire size, WFS, volts, trim, which wire feeder to use, or which feed head to use, but are not limited thereto.

While the above description focuses on the selection of a weld schedule as a function which is automatically selected and implemented, the welding job sequencer is not limited to using only this function.

For example, another possible function that may be selected and implemented by the welding job sequencer is a selection of one of multiple wire feeders on a single power source in accordance with the weld schedule. This function provides an even greater variability in welding jobs capable of being performed by the operator in the semi-automatic work cell, since different wire feeders can provide a great variance of, for example, wire sizes and types.

Another example of a function compatible with the welding job sequencer is a Quality Check function. This function performs a quality check of the weld (either during welding or after the weld is completed) before allowing the job sequence to continue. The quality check can monitor various welding parameters and can pause the welding operation and alert the operator if an abnormality is detected. An example of a welding parameter measurable by this function would be arc data.

Another example of such a function would be a Repeat function. This function would instruct the operator to repeat a particular weld or weld sequence. An example of the use of this function includes when the Quality Check function shows an abnormality, or when multiple instances of the same weld are required.

Another example of such a function would be a Notify Welder function, which communicates information to the welder. This function would display information, give an audible signal, or communicate with the welder by some other means. Examples of use of this function include an indication to the operator that he is free to begin welding, or an indication that the operator should check some portion of the welded part for quality purposes.

Another example of such a function would be a Enter Job Information function. This function will require the welder to enter information, such as the part serial number, a personal ID number, or other special conditions before the job sequencer can continue. This information could also be read from a part or inventory tag itself through Radio Frequency Identification (RFID), bar code scanning, or the like. The welding job sequencer could then utilize the entered information for the welding operations. An example of the use of this function would be as a predicate to the entire welding operation, so as to indicate to the welding job sequencer which schedules and/or sequences should be selected.

A further example of such a function would be a Job Report function. This function will create a report on the welding job, which could include information such as: the number of welds performed, total and individual arc timing, sequence interruptions, errors, faults, wire usage, arc data, and the like. An example of the use of this function would be to report to a manufacturing quality department on the efficiency and quality of the welding processes.

A still further example of such a function would be a System Check function. This function will establish whether the welding job can continue, and could monitor such parameters as: wire supply, gas supply, time left in the shift (as compared to the required time to finish the job), and the like. The function could then determine whether the parameters indicate that there is enough time and/or material for the welding job to continue. This function would prevent down-time due to material depletion, and would prevent work-in-process assemblies from being delayed, which can lead to quality problems due to thermal and scheduling issues.

Further, as mentioned above, the welding job sequencer may select and implement a new function, based upon various variables or inputs. These variables and inputs are not particularly limited, and can even be another function. For example, another function compatible with the welding job sequencer is a Perform Welding Operation function. This function is designed to detect the actual welding performed by the operator, and to report that welding so that the welding job sequencer can determine whether to proceed with further operations. For example, this function can operate by starting when the operator pulls the trigger to start the welding operation, and finishing when the operator releases the trigger after the welding is complete, or after a predetermined period of time after it starts. This function could end when the trigger is released or it could be configured to automatically turn off after a period of time, a quantity of wire, or an amount of energy is delivered. This function may be used to determine when to select a new function, such as a new weld schedule, as discussed above.

Still further, various semi-automatic and/or robotic work cells can be integrated together on a single network, and the sequencing of welding steps at a single work-cell can be fully integrated into a complete production schedule, which itself can be modified as needed to track variations in the production schedule. Sequencing and/or scheduling information can also be stored in a database, be stored by date as archival information, and be accessed to provide various production reports

In an embodiment, a semi-automatic welding work cell for welding an assembly defined by a plurality of welds can be provided, the plurality of welds being defined by at least two weld schedules can include welding equipment for use by a welding operator to perform said plurality of welds and complete the assembly with said welding equipment having a plurality of functions. In the embodiment, the work cell can include a welding job sequencer that automatically selects a welding schedule for use by an operator in the semi-automatic welding work cell. In the embodiment, the welding job sequencer can select the welding schedule according to an elapsed time. In an embodiment, the welding job sequencer can detect when the operator is conducting a welding operation, and selects the welding schedule based upon that detection. In the embodiment, the welding job sequencer can detect when the operator is conducting a welding operation, and the welding job sequencer selects the welding schedule according to an amount of welding wire supplied for the welding operation. In the embodiment, the welding job sequencer can detect when the operator is conducting a welding operation, and the welding job sequencer selects the welding schedule according to an amount of energy supplied for the welding operation. In the embodiment, the welding schedule includes information about at least one of a welding process, wire type, wire size, WFS, volts, trim, wire feeder to use, or feed head to use.

In an embodiment, the welding work cell can include the welding job sequencer which select and implements at least one of a plurality of functions to define at least a first weld schedule and a second weld schedule from the at least two weld schedules so as to organize a workflow for creating the welded assembly and indicate to the welding operator a sequence of working operations for completing the assembly. In the embodiment, the welding job sequencer can automatically modify the welding equipment in accordance with the workflow and sequence of the welding operations without the welding operator intervening.

In the embodiment, the second weld schedule is defined according to an elapsed time of the first weld schedule. In the embodiment, the at least one function detects completion of said first weld schedule by said operator and automatically changes from said first weld schedule to said second weld schedule. In the embodiment, at least one function detects when the operator is conducting said first weld schedule, and said second weld schedule is defined according to an amount of welding wire supplied for said first weld schedule. In the embodiment, at least one function detects when the operator is conducting said first weld schedule, and said second weld schedule is defined according to an amount of energy supplied for said first weld schedule. In the embodiment, the at least one first weld set up parameter and said at least one second weld set up parameter comprise at least one of a welding process, wire type, wire size, WFS, volts, trim, wire feeder to use, or feed head to use. In the embodiment, at least one first weld set up parameter and said at least one second weld set up parameter comprise a feeder for use by an operator in the semi-automatic welding work cell. In the embodiment, at least one function monitors quality measurables of said weld assembly, wherein the quality measureables comprise at least information about an arc used to form the weld created by the operator In the embodiment, at least one function indicates information to the operator in the semiautomatic welding work cell. In the embodiment, at least one function accepts job information comprising at least a part ID number, operator ID number, or welding instructions. In the embodiment, at least one function produces a job report comprising at least one of a number of welds preformed, total arc time, individual arc time, sequence interruptions, errors, faults, wire usage, arc data. In the embodiment, at least one function includes a system check of said cell, the system check comprising at least a detection of wire supply, gas supply, and time.

In the embodiment, the welding job sequencer can select a welding sequence for use by the operator in the semi-automatic welding work cell. In the embodiment, the welding job sequencer can indicate the selected welding sequence to the operator in the semi-automatic welding work cell. In the embodiment, the welding job sequencer can select a wire feeder for use by an operator in the semi-automatic welding work cell. In the embodiment, the welding job sequencer can monitor quality measurables of a weld created by the operator, wherein the quality measureables comprise at least information about an arc used to form the weld created by the operator. In the embodiment, the welding job sequencer can indicate information to the operator in the semi-automatic welding work cell. In the embodiment, the welding job sequencer can accept job information comprising at least a part ID number, operator ID number, or welding instructions. In the embodiment, the welding job sequencer can produce a job report comprising at least one of a number of welds preformed, total arc time, individual arc time, sequence interruptions, errors, faults, wire usage, arc data. In the embodiment, the welding job sequencer can perform a system check comprising at least a detection of wire supply, gas supply, and time.

In an embodiment, a method of welding in a semi-automatic work cell can be provided that includes automatically selecting a welding schedule for use by an operator in the semi-automatic welding work cell. In the embodiment, the automatic selection can be performed after an elapsed time. In the embodiment, the method can include detecting when the operator is conducting a welding operation, wherein the automatic selection is performed based upon that detection. In the embodiment, the method can include detecting when the operator is conducting a welding operation, wherein the automatic selection is performed according to an amount of welding wire supplied for the welding operation. In the embodiment, the method can include detecting when the operator is conducting a welding operation, wherein the automatic selection is performed according to an amount of energy supplied for the welding operation. In the embodiment, the welding schedule can include information about at least one of a welding process, wire type, wire size, WFS, volts, trim, wire feeder to use, or feed head to use.

In the embodiment, the method can include selecting a welding sequence for use by the operator in the semi-automatic welding work cell. In the embodiment, the method can include indicating the selected welding sequence to the operator in the semi-automatic welding work cell. In the embodiment, the method can include selecting a wire feeder for use by an operator in the semi-automatic welding work cell. In the embodiment, the method can include monitoring quality measurables of a weld created by the operator, wherein the quality measureables comprise at least information about an arc used to form the weld created by the operator. In the embodiment, the method can include indicating information to the operator in the semi-automatic welding work cell. In the embodiment, the method can include accepting job information comprising at least a part ID number, operator ID number, or welding instructions. In the embodiment, the method can include producing a job report comprising at least one of a number of welds performed, total arc time, individual arc time, sequence interruptions, errors, faults, wire usage, arc data. In the embodiment, the method can include performing a system check comprising at least a detection of wire supply, gas supply, and time.

In an embodiment, a welding production line is provided with at least one semi-automatic welding work cell, wherein the semi-automatic work cell that includes a welding job sequencer that automatically selects a welding schedule for use by an operator therein. In the embodiment, the welding production line includes a monitoring system that communicates with the welding job sequencer to direct the welding job sequencer to automatically select the welding schedule for use by the operator therein.

In an embodiment, a method of monitoring a welding production line is provided that includes automatically selecting a welding schedule for use by an operator in a semi-automatic welding work cell. In the embodiment, the method can include directing the welding job sequencer to automatically select the welding schedule for use by the operator therein.

In an embodiment, a semi-automatic welding work cell is provided that includes a welding job sequencer that automatically selects a welding schedule for use by an operator in the semi-automatic welding work cell. The automatic selection may be by way of elapsed time, a detection of welding operations, a detection of the amount of welding wire supplied for the welding operation, or a detection of the amount of energy supplied for the welding operation.

In an embodiment, a method of welding in a semi-automatic work cell having welding equipment and a welding job sequencer to complete an assembly defined by a plurality of welds can be provided in which the plurality of welds can be defined by at least two weld schedules. The embodiment can include at least the steps of the following: implementing a welding equipment function with the welding job sequencer to define from the at least two weld schedules a first weld schedule having at least one first weld set up parameter and at least one first weld instruction and a second weld schedule having at least one second weld set up parameter and at least one second weld instruction, at least one of the said second weld set up parameter and said second weld instruction is different from said first weld set up parameter and said first weld instruction; indicating to a welding operator a sequence of welding operations for completing the assembly based on said first and second weld schedules; and automatically modifying said welding equipment in accordance with said sequence of welding operations for completing the assembly based on said first and second weld schedules.

In the embodiment, the method can include defining said second weld schedule is performed after an elapsed time defined by said first weld schedule. In the embodiment, the method can include detecting when the operator is conducting said first weld schedule, wherein defining said second schedule is based upon that detection. In the embodiment, defining said first and second weld schedules can include defining an amount of welding wire supplied for the welding operation. In the embodiment, defining said second weld schedule is according to an amount of energy supplied for the welding operation for said first weld schedule. In the embodiment, defining at least one of the first and second weld schedules can include selecting at least one of a welding process, wire type, wire size, WFS, volts, trim, wire feeder to use, or feed bead to use. In an embodiment, defining at least one of the first and second weld schedules can include selecting a wire feeder for use by an operator in the semi-automatic welding work cell. In an embodiment, the method can include monitoring quality measurables of a weld created by the operator, wherein the quality measureables comprise at least information about an arc used to form the weld created by the operator. In an embodiment, the method can include indicating information to the operator in the semi-automatic welding work cell. In an embodiment, the method can include accepting job information comprising at least a part ID number, operator ID number, or welding instructions. In an embodiment, the method can include producing a job report comprising at least one of a number of welds performed, total arc time, individual arc time, sequence interruptions, errors, faults, wire usage, arc data performing a system check comprising at least a detection of wire supply, gas supply, and time.

In an embodiment, a welding production line is provided that includes at least one semi-automatic welding work cell for welding an assembly defined by a plurality of welds, the plurality of welds being defined by at least weld schedules, the semi-automatic welding work cell including welding equipment for use by a welding operator to perform the plurality of welds and complete the assembly, the welding equipment having a plurality of functions. In the embodiment, the production line can include a welding job sequencer which selects and implements at least one of the plurality of functions to define at least a first and a second weld schedule in a sequence of welding operations from the at least two weld schedules to be used by said welding operator for completing the weld assembly. In an embodiment, the production line can include said first weld schedule contains at least one first weld set up parameter and at least one first weld instruction for said welding operator and said second weld schedule contains at least one second weld set up parameter and at least one second weld instruction for said welding operator, at least one of said first weld set up parameter and said first weld instruction is different from said second weld set up parameter and said second weld instruction, said welding job sequencer automatically modifying said welding equipment in accordance with said sequence of operations without said welding operator intervention. In an embodiment, the production line can include a monitoring system in communication with the welding job sequencer to monitor completion of the at least one weld instruction of each of the first and second weld schedule.

In an embodiment, a method for monitoring a welding production line in at least one semi-automatic welding work cell for use by a welding operator to complete an assembly defined by a plurality of welds, the plurality of welds being defined by at least two weld schedules, the semi-automatic welding work cell including welding equipment and a welding job sequencer. The method can include at least the following steps: defining at least a first and a second weld schedule in a sequence of welding operations from the at least two weld schedules with the welding job sequencer said first weld schedule having at least one first weld set up parameter and at least one first weld instruction and said second weld schedule defining at least one second weld set up parameter and at least one second weld instruction with at least one of said second weld set up parameter and said second weld instruction being different from said first weld set up parameter and said first weld instruction; determining completion of said first weld schedule by said welding operator; automatically modifying the welding equipment in accordance with said second weld schedule without said welding operator intervention; and monitoring the welding operations. In the embodiment, the method can include automatically modifying the welding equipment in accordance with said second weld schedule is based on said completion of said first weld schedule.

In an embodiment, a semi-automatic welding work cell for use by an operator is provided. The embodiment can include welding equipment having a plurality of functions for performing welds by the operator and a welding job sequencer selecting from the plurality of functions to set up and organize the welding equipment for the operator. The embodiment can include the plurality of functions including: a weld schedule function defined by a sequence of weld operations; a notify function to instruct the operator to perform the weld schedule; and a quality check function to monitor at least one weld operation of the sequence of weld operations.

In the embodiment, the quality check function performs a quality check on a weld completed by the at least one weld operation. In the embodiment, the quality check function monitors the at least one weld operation during the at least one weld operation. In the embodiment, the quality check function monitors the at least one weld operation after completion of the at least one weld operation. In the embodiment, the weld schedule function defines a plurality of weld schedules, each weld schedule having a first weld operation and at least a second weld operation. In the embodiment, the quality check function monitors the at least one weld operation before allowing the sequence of weld operations to continue. In the embodiment, the quality check function detects an abnormality, the sequencer pauses the sequence of weld operations and the notify function alerts the operator of the abnormality.

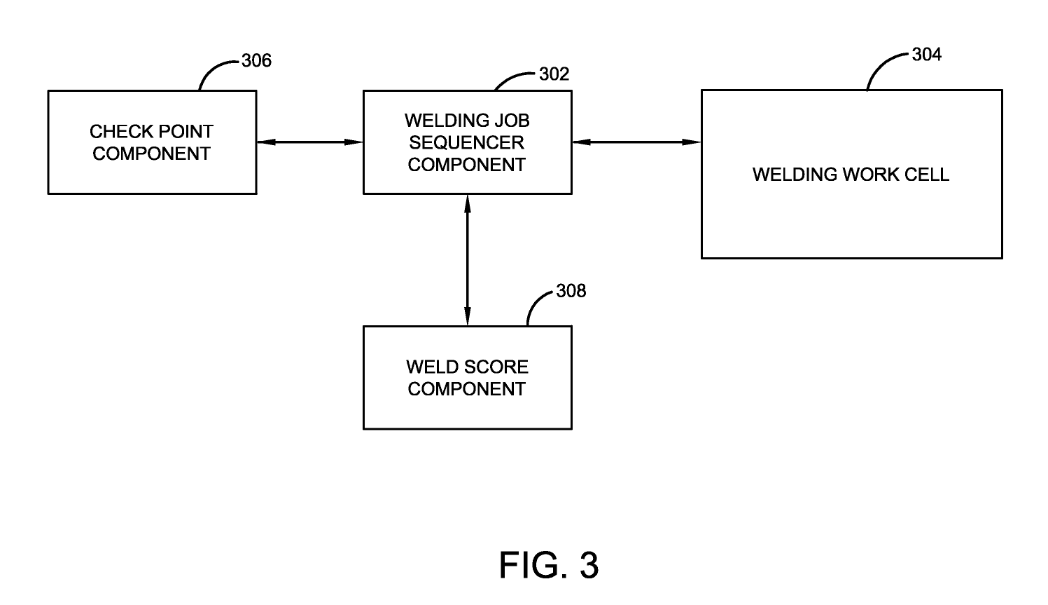

FIG. 3 is a schematic block diagram of an exemplary embodiment of welding system 300 that utilizes welding job sequencer component 302 to configure welding equipment for two or more weld operations to assembly a workpiece. Welding job sequencer component 302 that is configured to implement a welding sequence that includes settings, configurations, and/or parameters to perform two or more welding procedures on a workpiece. In particular, welding job sequencer component 302, as discussed above as welding job sequencer, automatically configures welding equipment to create two or more welds that include two or more welding schedules. Moreover, welding job sequencer component 302 utilizes the welding sequence to aid an operator to perform the two or more welds. As discussed above, welding job sequencer component 302 can be utilized with welding work cell 304 that is semi-automatic. However, it is to be appreciated and understood that welding job sequencer component 302 can be implemented in a suitable welding environment or system that includes at least welding equipment and an operator to facilitate creating one or more welds.

Welding system 300 further includes check point component 306 that is configured to monitor a welding process and/or a welding operator in real time. For instance, the welding process is monitored in real time to detect at least one of a welding parameter (e.g., voltage, current, among others), a welding schedule parameter (e.g., welding process, wire type, wire size, WFS, volts, trim, wire feeder to use, feed head to use, among others), a weld on a workpiece as the weld is created, a movement of an operator, a position of a welding tool, a position or location of a welding equipment, a position or location of an operator, sensor data (e.g., video camera, image capture, thermal imaging device, heat sensing camera, temperature sensor, among others), and the like. Check point component 306 includes an alert system (not shown) that can communicate an alert or notification to indicate a status of the real time monitoring. In an embodiment, check point component 306 can utilize thresholds, ranges, limits, and the like for the real time monitoring to precisely identify a abnormality with welding system 300. Furthermore, check point component 306 can communicate an alert or notification to welding work cell 304 or the operator to at least one of stop the welding procedure, continue with the welding procedure, pause the welding procedure, terminate the welding procedure, or request approval of the welding procedure. In an embodiment, check point component 306 can store monitoring data (e.g., video, images, results, sensor data, and the like) in at least one of a server, a data store, a cloud, a combination thereof, among others.

Weld score component 308 is included with welding system 300 and is configured to evaluate a weld created by an operator within welding work cell 304 upon completion of such weld. Weld score component 308 provides a rating or score for the completed weld to facilitate implementing a quality control on the workpiece and/or assembly of the workpiece. For instance, weld score component 308 can alert a quality inspection upon completion, provide data collection of a job (e.g., assembly of workpiece, weld on workpiece, among others), and the like. In an embodiment, an in-person quality inspection can be performed upon completion of a portion of the assembly (e.g., completion of a weld, completion of two or more welds, completion of assembly, among others). In another embodiment, weld score component 308 can utilize a sensor to collect data (e.g., video camera, image capture, thermal imaging device, heat sensing camera, temperature sensor, among others) to determine approval of the job. For instance, a quality inspection can be performed remotely via video or image data collected upon completion of a job.

It is to be appreciated that welding job sequencer component 302 can be a stand-alone component (as depicted), incorporated into welding work cell 304, incorporated into check point component 306, incorporated into weld score component 308, or a suitable combination thereof. Additionally, as discussed below, welding job sequencer component 302 can be a distributed system, software-as-a-service (SaaS), a cloud-based system, or a combination thereof. Further, it is to be appreciated and understood that check point component 306 can be a stand-alone component (as depicted), incorporated into welding work cell 304, incorporated into welding job sequencer component 302, incorporated into weld score component 308, or a suitable combination thereof. Additionally, check point component 306 can be a distributed system, software-as-a-service (SaaS), a cloud-based system, or a combination thereof. Moreover, it is to be appreciated and understood that weld score component 308 can be a stand-alone component (as depicted), incorporated into welding work cell 304, incorporated into welding job sequencer component 302, incorporated into check point component 306, or a suitable combination thereof. Additionally, weld score component 308 can be a distributed system, software-as-a-service (SaaS), a cloud-based system, or a combination thereof.

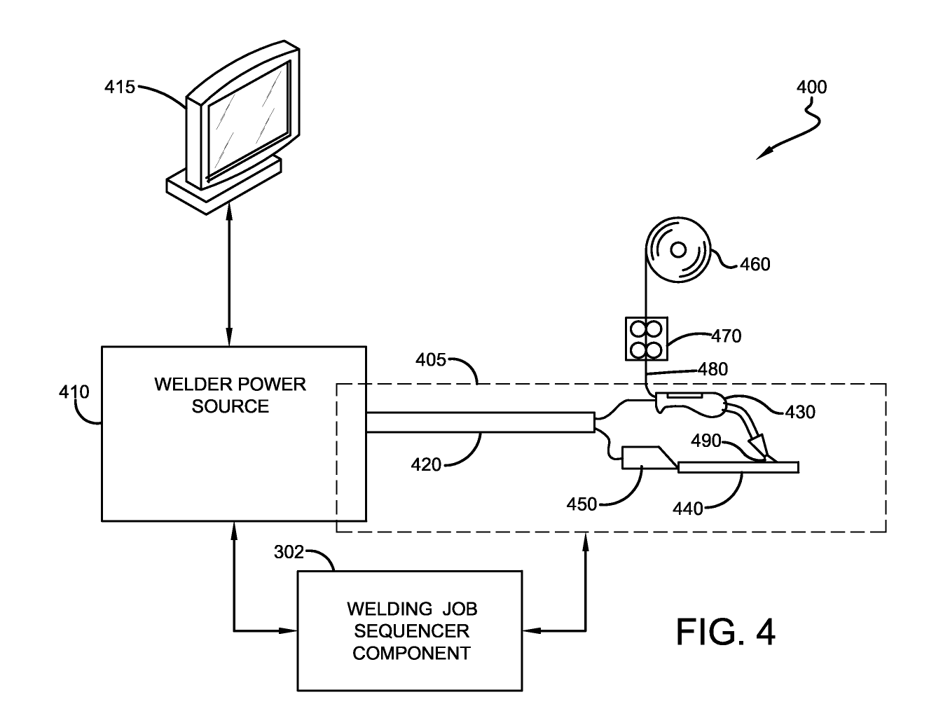

FIG. 4 illustrates a schematic block diagram of an exemplary embodiment of welding system 400 including welding circuit path 405. It is to be appreciated that welding system 400 is also referred to as the welding work cell, wherein the welding work cell and/or welding system 400 can produce welds or welded parts. Welding system 400 includes welder power source 410 and display 415 operationally connected to welder power source 410. Alternatively, display 415 may be an integral part of welder power source 410. For instance, display 415 can be incorporated into welder power source 410, a stand-alone component (as depicted), or a combination thereof. Welding system 100 further includes welding cable 120, welding tool 430, workpiece connector 450, spool of wire 460, wire feeder 470, wire 480, and workpiece 440. Wire 480 is fed into welding tool 430 from spool 460 via wire feeder 470, in accordance with an embodiment of the present invention. In accordance with another embodiment of the present invention, welding system 400 does not include spool of wire 460, wire feeder 470, or wire 480 but, instead, includes a welding tool comprising a consumable electrode such as used in, for example, stick welding. In accordance with various embodiments of the present invention, welding tool 430 may include at least one of a welding torch, a welding gun, and a welding consumable.

Welding circuit path 405 runs from welder power source 410 through welding cable 420 to welding tool 430, through workpiece 440 and/or to workpiece connector 450, and back through welding cable 420 to welder power source 110. During operation, electrical current runs through welding circuit path 405 as a voltage is applied to welding circuit path 405. In accordance with an exemplary embodiment, welding cable 420 comprises a coaxial cable assembly. In accordance with another embodiment, welding cable 420 comprises a first cable length running from welder power source 410 to welding tool 430, and a second cable length running from workpiece connector 450 to welder power source 410.

Welding system 400 includes welding job sequencer component 302 (as described above). Welding job sequencer component 302 is configured to interact with a portion of welding system 400. For instance, welding job sequencer component 302 can interact with at least the power source 410, a portion of welding circuit path 405, spool of wire 460, wire feeder 470, or a combination thereof. Welding job sequencer component 302 automatically adjusts one or more elements of welding system 400 based on a welding sequence, wherein the welding sequence is utilized to configure welding system 400 (or an element thereof) without operator intervention in order to perform two or more welding procedures with respective settings or configurations for each welding procedure.

In an embodiment, welding job sequencer component 302 employs a welding sequence to automatically configure welding equipment. It is to be appreciated that welding system 400 or welding work cell can employ a plurality of welding sequences for assembly of one or more workpieces. For instance, a workpiece can include three (3) welds to complete assembly in which a first welding sequence can be used for the first weld, a second welding sequence can be used for the second weld, and a third welding sequence can be used for the third weld. Moreover, in such example, the entire assembly of the workpiece including the three (3) welds can be referenced as a welding sequence. In an embodiment, a welding sequence that includes specific configurations or steps can further be included within a disparate welding sequence (e.g., nested welding sequence). A nested welding sequence can be a welding sequence that includes a welding sequence as part of the procedure. Moreover, the welding sequence can include at least one of a parameter, a welding schedule, a portion of a welding schedule, a step-by-step instruction, a portion of media (e.g., images, video, text, and the like), a tutorial, among others. In general, the welding sequence can be created and employed in order to guide an operator through welding procedure(s) for specific workpieces without the operator manually setting welding equipment to perform such welding procedures. The subject innovation relates to creating a welding sequence and/or modifying a welding sequence.

One or more welder power source(s) (e.g., welder power source 410) aggregates data respective to a respective welding process to which the welder power source is providing power to implement. Such collected data relates to each welder power source and is herein referred to as “weld data.” Weld data can include welding parameters and/or information specific to the particular welding process the welder power source is supplying power. For instance, weld data can be an output (e.g., a waveform, a signature, a voltage, a current, among others), a weld time, a power consumption, a welding parameter for a welding process, a welder power source output for the welding process, and the like. In an embodiment, weld data can be utilized with welding job sequencer component 302. For example, weld data can be set by a welding sequence. In another example, weld data can be used as a feedback or a feedforward loop to verify settings.

In one embodiment, welding job sequencer component 302 is a computer operable to execute the disclosed methodologies and processes, including methods 1100 and 1200 described herein. In order to provide additional context for various aspects of the present invention, the following discussion is intended to provide a brief, general description of a suitable computing environment in which the various aspects of the present invention may be implemented. While the invention has been described above in the general context of computer-executable instructions that may run on one or more computers, those skilled in the art will recognize that the invention also may be implemented in combination with other program modules and/or as a combination of hardware and/or software. Generally, program modules include routines, programs, components, data structures, etc., that perform particular tasks or implement particular abstract data types.

Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like, each of which may be operatively coupled to one or more associated devices. The illustrated aspects of the invention may also be practiced in distributed computing environments where certain tasks are performed by remote processing devices that are linked through a communications network. In a distributed computing environment, program modules may be located in both local and remote memory storage devices. For instance, a remote database, a local database, a cloud-computing platform, a cloud database, or a combination thereof can be utilized with welding job sequencer 302.

Welding job sequencer 302 can utilize an exemplary environment for implementing various aspects of the invention including a computer, wherein the computer includes a processing unit, a system memory and a system bus. The system bus couples system components including, but not limited to the system memory to the processing unit. The processing unit may be any of various commercially available processors. Dual microprocessors and other multi-processor architectures also can be employed as the processing unit.

The system bus can be any of several types of bus structure including a memory bus or memory controller, a peripheral bus and a local bus using any of a variety of commercially available bus architectures. The system memory can include read only memory (ROM) and random access memory (RAM). A basic input/output system (BIOS), containing the basic routines that help to transfer information between elements within welding job sequencer 302, such as during start-up, is stored in the ROM.

Welding job sequencer 302 can further include a hard disk drive, a magnetic disk drive, e.g., to read from or write to a removable disk, and an optical disk drive, e.g., for reading a CD-ROM disk or to read from or write to other optical media. Welding job sequencer 302 can include at least some form of computer readable media. Computer readable media can be any available media that can be accessed by the computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other magnetic storage devices, or any other medium which can be used to store the desired information and which can be accessed by welding job sequencer 302.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, Radio Frequency (RF), Near Field Communications (NFC), Radio Frequency Identification (RFID), infrared, and/or other wireless media. Combinations of any of the above should also be included within the scope of computer readable media.

A number of program modules may be stored in the drives and RAM, including an operating system, one or more application programs, other program modules, and program data. The operating system in welding job sequencer 302 can be any of a number of commercially available operating systems.

In addition, a user may enter commands and information into the computer through a keyboard and a pointing device, such as a mouse. Other input devices may include a microphone, an IR remote control, a track ball, a pen input device, a joystick, a game pad, a digitizing tablet, a satellite dish, a scanner, or the like. These and other input devices are often connected to the processing unit through a serial port interface that is coupled to the system bus, but may be connected by other interfaces, such as a parallel port, a game port, a universal serial bus (“USB”), an IR interface, and/or various wireless technologies. A monitor (e.g., display 415), or other type of display device, may also be connected to the system bus via an interface, such as a video adapter. Visual output may also be accomplished through a remote display network protocol such as Remote Desktop Protocol, VNC, X-Window System, etc. In addition to visual output, a computer typically includes other peripheral output devices, such as speakers, printers, etc.

A display (in addition or in combination with display 415) can be employed with welding job sequencer 302 to present data that is electronically received from the processing unit. For example, the display can be an LCD, plasma, CRT, etc. monitor that presents data electronically. Alternatively or in addition, the display can present received data in a hard copy format such as a printer, facsimile, plotter etc. The display can present data in any color and can receive data from welding job sequencer 302 via any wireless or hard wire protocol and/or standard. In another example, welding job sequencer 302 and/or system 400 can be utilized with a mobile device such as a cellular phone, a smart phone, a tablet, a portable gaming device, a portable Internet browsing device, a Wi-Fi device, a Portable Digital Assistant (PDA), among others.

The computer can operate in a networked environment using logical and/or physical connections to one or more remote computers, such as a remote computer(s). The remote computer(s) can be a workstation, a server computer, a router, a personal computer, microprocessor based entertainment appliance, a peer device or other common network node, and typically includes many or all of the elements described relative to the computer. The logical connections depicted include a local area network (LAN) and a wide area network (WAN). Such networking environments are commonplace in offices, enterprise-wide computer networks, intranets and the Internet.

When used in a LAN networking environment, the computer is connected to the local network through a network interface or adapter. When used in a WAN networking environment, the computer typically includes a modem, or is connected to a communications server on the LAN, or has other means for establishing communications over the WAN, such as the Internet. In a networked environment, program modules depicted relative to the computer, or portions thereof, may be stored in the remote memory storage device. It will be appreciated that network connections described herein are exemplary and other means of establishing a communications link between the computers may be used.

Alternatively or in addition, a local or cloud (e.g., local, cloud, remote, among others) computing platform can be utilized for data aggregation, processing, and delivery. For this purpose, the cloud computing platform can include a plurality of processors, memory, and servers in a particular remote location. Under a software-as-a-service (SaaS) paradigm, a single application is employed by a plurality of users to access data resident in the cloud. In this manner, processing requirements at a local level are mitigated as data processing is generally done in the cloud, thereby relieving user network resources. The software-as-a-service application allows users to log into a web-based service (e.g., via a web browser) which hosts all the programs resident in the cloud.

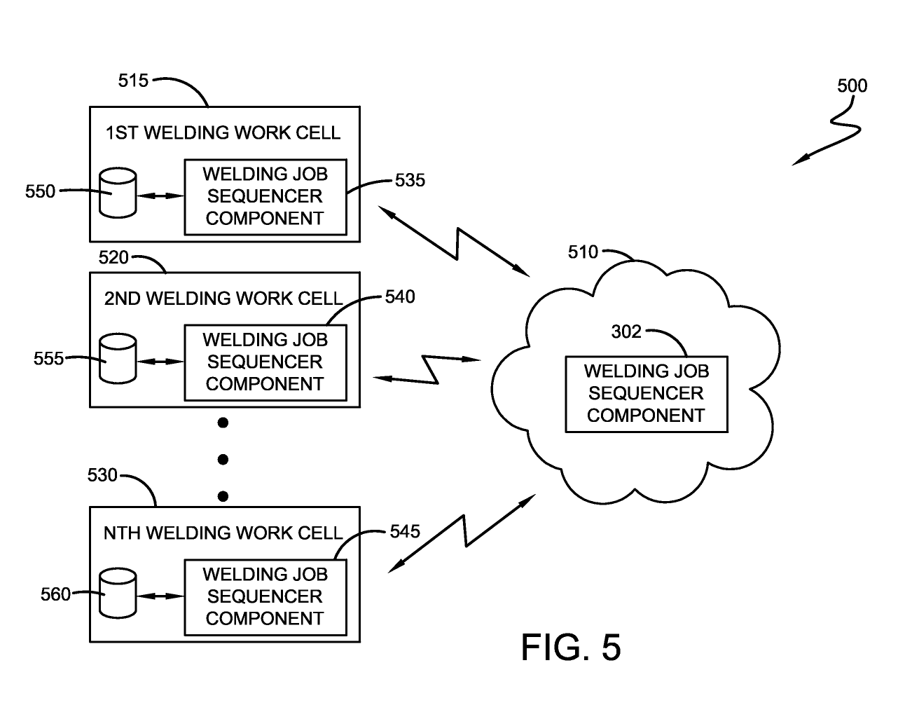

Turning to FIG. 5, system 500 illustrates a welding environment with a plurality of welding work cells via a local, remote, or cloud database. System 500 includes a plurality of welding work cells such as first welding work cell 515, second welding work cell 520 to Nth welding work cell 530, where N is a positive integer. In an embodiment, each welding work cell includes a welding job sequencer component 535, 540, and 545, that is used to implement a welding schedule(s) to each welding work cell as well as or in the alternative to an enterprise-wide welding operation(s) and/or enterprise-wide welding work cell. Welding sequence(s) from each welding job sequencer component 535, 540, and 545 is received from the local or cloud database (e.g., local database, cloud database, remote database, among others) computing platform 510.

In an embodiment, each welding work cell further includes a local data store. For instance, first welding work cell 515 includes welding job sequencer component 535 and data store 550, second welding work cell 520 includes welding job sequencer component 540 and data store 555, and Nth welding work cell 530 includes welding job sequencer component 545 and data store 560. It is to be appreciated that system 500 includes welding job sequencer 302 hosted by computing platform 510 in which each welding work cell includes a distributed and respective welding job sequencer component. Yet, it is to be understood that welding job sequencer 302 (and distributed welding job sequencer components 535, 540, and 545) can be a stand-alone component in each welding work cell or a stand-alone component in the computing platform 510.

Each welding work cell can include a respective data store that stores a portion of at least one welding sequence. For instance, welding sequences related to a welding process A is employed at one or more welding work cell. The welding sequence is stored in a respective local data store (e.g., data stores 550, 555, and 560). Yet, it is to be appreciated and understood that each welding work cell can include a local data store (as depicted), a collective and shared remote data store, a collective and shared local data store, a cloud data store hosted by computing platform 510, or a combination thereof. A “data store” or “memory” can be, for example, either volatile memory or nonvolatile memory, or can include both volatile and nonvolatile memory. The data store of the subject systems and methods is intended to comprise, without being limited to, these and other suitable types of memory. In addition, the data store can be a server, a database, a hard drive, a flash drive, an external hard drive, a portable hard drive, a cloud-based storage, a solid-state drive, and the like.

For instance, welding job sequencer component 302 can manage each welding job sequencer component 535, 540, 545 in each welding work cell 515, 520, 530. In another embodiment, the communications can be transmitted from the welding job sequencer 302 to each welding work cell (e.g., each welding job sequencer component). In another embodiment, the communications can be received from each welding work cell (e.g., each welding job sequencer component) from the welding job sequencer component 302. For instance, a welding sequence can be used with 1^{st} welding work cell 515 and communicated directly to a disparate welding work cell or via computing platform 510.

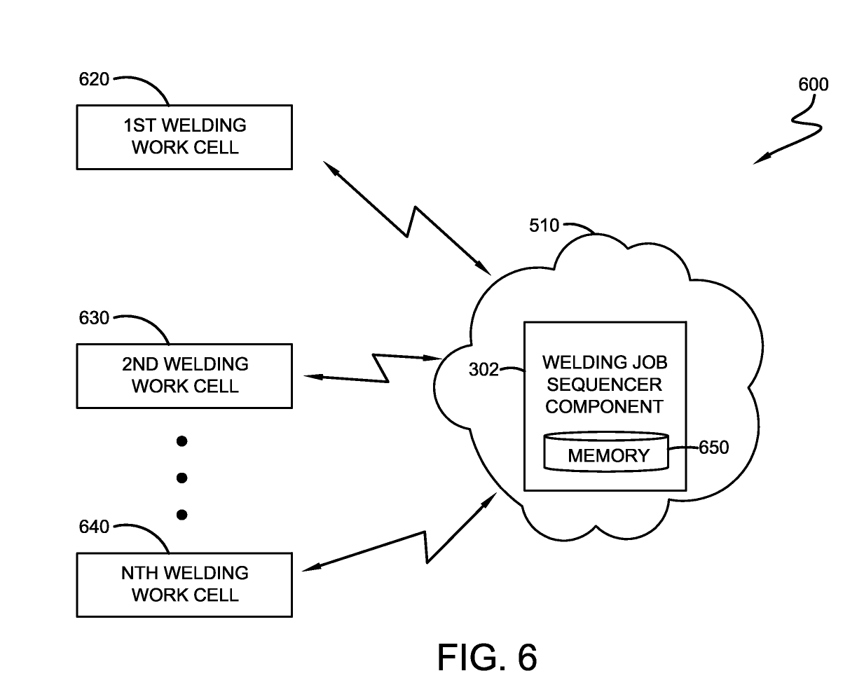

FIG. 6 illustrates welding system 600 that includes a plurality of welding work cells in which welding job sequencer component 302 is hosted with computing platform 510 to utilize one or more welding sequences to configure welding equipment within one or more welding systems, welding environments, and/or welding work cells. Welding system 600 includes a local or cloud-based welding job sequencer component 302 hosted in computing platform 510. Welding job sequencer component 302 can utilize a welding sequence with a number of welding work cell. For instance, welding system 600 can a number of welding work cells such as, but not limited to, 1^{st} welding work cell 620, 2^{nd} welding work cell 630, to Nth welding work cell, where N is a positive integer. It is to be appreciated that the locality of the welding job sequencer component 302 is in relation to each 1^{st} welding work cell 620, 2^{nd} welding work cell 630, and/or Nth welding work cell 640.

In an embodiment, welding job sequencer 302 communicates one or more welding sequence to a target welding work cell, wherein the target welding work cell is a welding work cell that is to utilize the communicated welding sequence. Yet, in another embodiment, welding job sequencer 302 utilizes memory 650 hosted by computing platform 510 in which one or more welding sequences are stored. Yet, the stored welding sequence can be related or targeted to one or more welding work cells regardless of a storage location (e.g., local, cloud, remote, among others).

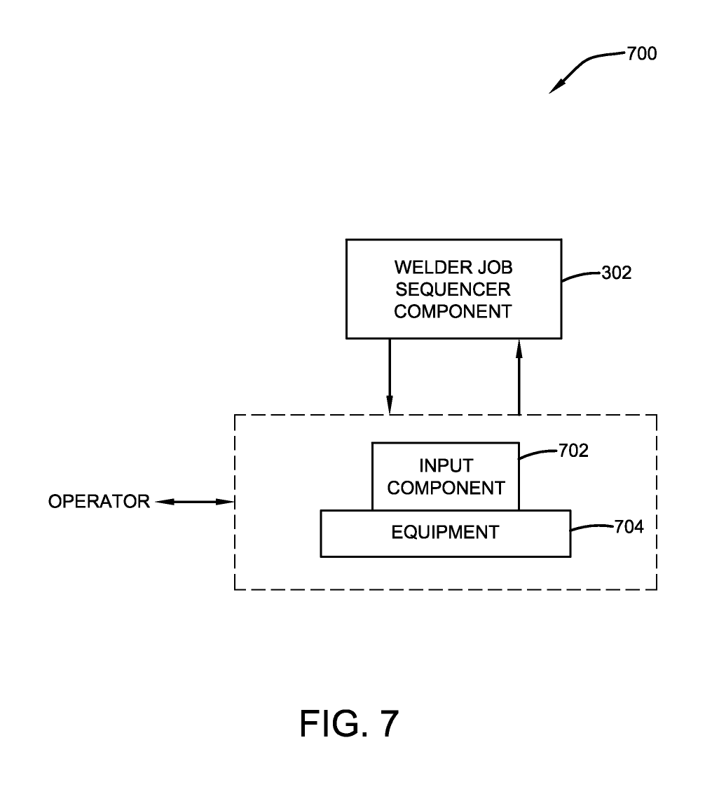

FIG. 7 illustrates system 700 that communicates with an operator during performance of a weld with a welding sequence. System 700 includes welding input component 702 that is configured to receive an input from an operator during a welding operation. It is to be appreciated that the welding operation utilizes a welding sequence and/or welding job sequencer component 302 to automate configurations of welding equipment for two or more welds in assembly of a workpiece. Input component 702 communicates with the operator during the welding operation that is using one or more welding sequences. For instance, a portion of data can be received and communicated to the operator via input component 702. For example, a welding operation progress can be displayed to the operator for the specific welding sequence and/or welding operation. In another embodiment, a portion of data can be received and communicated to the welding job sequencer component 302 via input component 702. For example, an indication from the operator can be communicated that relates to completion of a weld on a particular workpiece using the welding sequence (e.g., completion of a portion of the welding sequence, completion of a step in the welding sequence, among others).

Input component 702 enables control of a portion of the welding sequence and/or welding job sequencer component 302 during performance of a welding operation. It is to be appreciated that the control can include, but is not limited to, starting the welding sequence, stopping the welding sequence, requesting for a check of a weld, halting the welding sequence, verification of a weld, request for a replenishment of a consumable, request service or maintenance, restarting a welding sequence, restart a step in the welding sequence, pausing a welding sequence, input communicating completion of a welding operation on a workpiece, input communicating beginning of a welding operation on a workpiece, input communicating completion of a weld of a welding operation, input communicating beginning of a weld of a welding operation, shutdown of equipment, among others. It is to be appreciated and understood that the above controls are solely for example and that any suitable control used with the welding sequence and/or welding job sequencer component 302 is intended to be included with the subject innovation.

System 700 further includes an equipment 704. Equipment 704 can be, but is not limited to being, equipment that the operator uses, wears, or carries during a performance of a welding operation. By way of example and not limitation, equipment 704 can be a helmet, a visor, a pair of glasses, a glove, an apron, a jacket, a welding sleeve, an identification badge of the operator, an earpiece, a pair of headphones, an ear plug, a headband, a bandana, a watch, an item of jewelry (e.g., ring, necklace, bracelet, among others), and the like. It is to be appreciated that input component 702 can be a stand-alone component, incorporated into equipment 704, affixed to equipment 704, worn by the operator, temporarily coupled to equipment 704 (e.g., affixed with a wearable holder or case, Velcro, among others), and/or a combination thereof.

In an embodiment, input component 702 includes at least one button to receive the input from the operator. In another embodiment, input component 702 includes at least one of a display to communicate data related to welding job sequencer component 302 or a touchscreen to interact with welding job sequencer component 302. In still another embodiment, input component 302 includes a component to vibrate based on a signal received via the welding job sequencer component. Furthermore, an embodiment can provide input component 702 with a button, a display, a touchscreen, and/or a haptic feedback component to interact or manage welding job sequencer component 302 and/or welding sequence(s).

In an embodiment, input device 702 provides feedback from welding job sequencer component 302 to the operator. The feedback can relate to welding equipment (e.g., settings, real time measurements, among others), performance (e.g., weld score, ranking based on comparison with other operators, and the like), job information (e.g., workpiece number, welding duration of time, number of welds, measurement of length of welds made, date, time, among others), or a combination thereof. In another embodiment, input component 702 can provide haptic feedback to the operator during the welding procedure. The haptic feedback can correspond to whether the weld being created by the operator is meeting a condition (e.g., size or dimension of weld, duration of time to create, location of weld, among others). For instance, a haptic feedback (e.g., a motion, vibration, movement, and the like) to the operator can communicate to the operator that the current weld being created is falling short of a quality requirement (e.g., dimension, size, among others).

In an example, welding job sequencer component 302 uses a welding sequence that can include a replenishment of a consumable. The welding sequence can be created or edited to include a replenishment of a consumable for at least one of a welding work cell, a welding equipment, among others. For instance, a replenishment of a consumable can be included with a welding sequence after a period of time, wherein the period of time is estimated based on the duration the welding equipment is used (e.g., estimate the use of consumables). Thus, a welding environment, welding system, and/or welding work cell can be evaluated in real time or from collected real time data and identify data to determine a replenishment of a consumable. Moreover, the welding sequence can include a step to replenish the consumable based on estimations of the consumable remaining and/or real time monitoring of the consumable. Moreover, as discussed in more detail below, a welding sequence can be halted based upon the monitoring of a consumable to allow time for replenishment. In an embodiment, the welding sequence is continued after replenishment of the consumable. For instance, the operator can utilize the input component 702 to halt a welding sequence, request replenishment of a consumable, and continuation of the welding sequence.

In another example, welding job sequencer component 302 uses a welding sequence that can include an inspection or a repair. The welding sequence can be created or edited to include an inspection request or a repair request based on a factor such as, but not limited to, a time, a duration, among others. A welding work cell can have a maintenance period for a particular time and if a welding sequence is created for such welding work cell, a repair or maintenance can be included with the created welding sequence. Thus, a welding environment, welding system, and/or welding work cell can be evaluated in real time or from collected real time data and identify data to determine inspections or repairs. Moreover, the welding sequence can include a step to inspect or repair for a portion of the welding work cell based on estimations of equipment life and/or real time monitoring of the portion(s) of the welding work cell. Additionally, as discussed in more detail below, a welding sequence can be halted based upon the monitoring to allow time for repair and/or maintenance. In an embodiment, the welding sequence is continued after repair and/or maintenance of the portion(s) of the welding work cell. For instance, the operator can utilize the input component 702 to halt a welding sequence, request inspection or repair, and continuation of the welding sequence.

In another example, welding job sequencer component 302 uses a welding sequence can include a pre-shift routine that is performed prior to a welding operation. For instance, a shift can be part of a scheduling of operators or employees, wherein the shift is a duration of time when operators are working. As an example, a shift can be from seven (7) am to three (3) pm. Based on gathered historic welding data or real time welding data, an estimation of welding time can be calculated to facilitate determining maintenance to perform on welding equipment. In an embodiment, at least one of gas flow, tip condition, tip replacement, nozzle inspection, nozzle replacement, among others can be included within a welding sequence based on the estimation of welding time. Moreover, the welding sequence can include a step to perform a pre-shift routine. Additionally, as discussed in more detail below, a welding sequence can be halted in order to perform the pre-shift routine. In an embodiment, the welding sequence is continued after the pre-shift routine is performed. For instance, the operator can utilize the input component 702 to halt a welding sequence, request pre-shift routines to be performed, and continuation of the welding sequence.

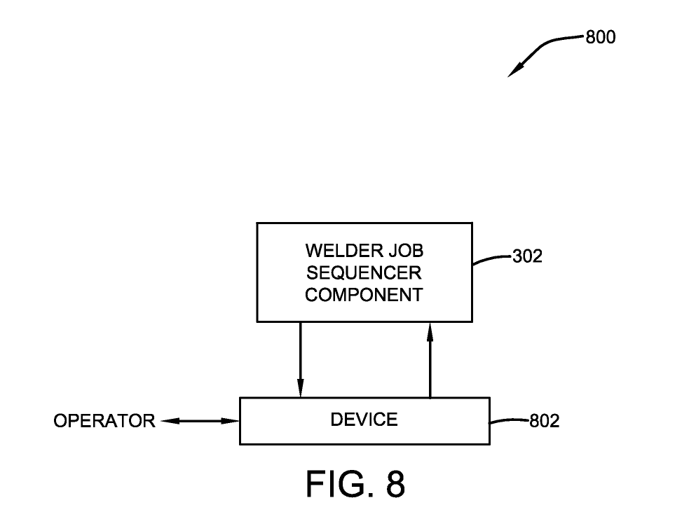

FIG. 8 illustrates system 800 that interfaces one or more components to perform a welding procedure using a welding sequence. System 800 further includes device 802 that communicates with welding job sequencer component 302 and/or a welding sequence utilized by welding job sequencer component 302. The operator can interact with device 802 to control or manage welding job sequencer component 302 and/or a welding job sequencer during a weld operation in real time. For instance, once a welding sequence is identified and being utilized by an operator, the operator begins a welding operation. While this welding operation is being performed, device 802 can be utilized to control or manage use of the welding sequence and/or welding job sequencer component 302.

In an embodiment, device 802 is a portable device. By way of example and not limitation, device 802 can be a motion sensor device (e.g., motion device that detects a portion of body movement), a controller and movement sensor (e.g., controller is used to detect a body motion from an operator), a wireless fidelity (WiFi) device, a tablet, a laptop, a touchscreen, an accelerometer device, a gaming device, a smartphone, a voice recognition device, a microphone, a pressure sensor (e.g., incorporated into a mat or area within welding range of the workpiece), a foot pedal, a movement sensor for a foot, and the like. In an embodiment, device 802 incorporates input device (not shown but discussed in FIG. 7).

In a particular embodiment, device 802 is utilized to control a welding sequence, a portion of a welding sequence, and/or welding job sequencer component 302 when the operator is a specified distance from welding equipment performing the welding operation or the immediate welding area. For instance, device 802 can utilize voice commands from the operator and voice recognition to facilitate control. In another instance, an accelerometer device can be used to detect a signal for controlling a portion of the welding sequence and/or welding job sequencer component 302. In such instance, a position for the accelerometer may be used. Moreover, a detection of the acceleration from the accelerometer device can be used as an input from the operator. For instance, an operator may wave his or her arm to activate a next step in a welding sequence based on an accelerometer detecting the acceleration of the arm movement. It is to be appreciated that the acceleration rate detected can be correlated with an urgency for the control. In another example, a rapid movement may indicate an emergency stoppage.

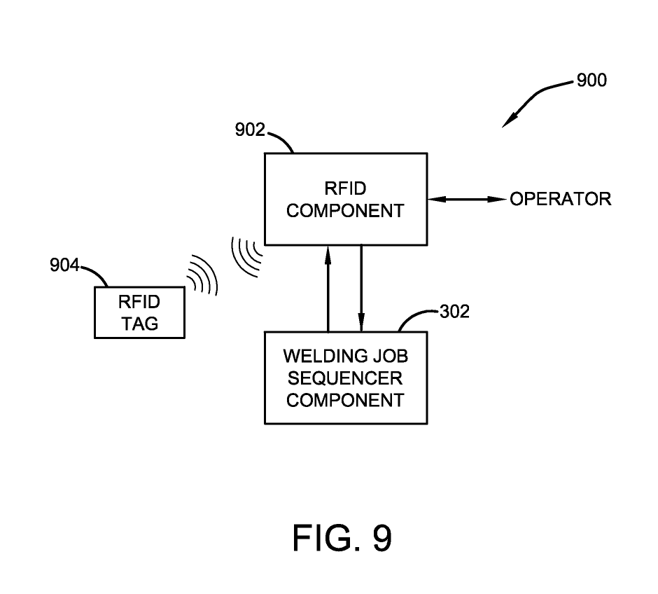

FIG. 9 illustrates system 900 that uses a Radio Frequency Identification (RFID) tag to control use of a welding sequence in a welding work cell. System 900 includes Radio Frequency Identification (RFID) component 902 (herein referred to as RFID component or RFID reader) that is configured to receive or collect wireless data from RFID tag 904. In an embodiment, RFID tag 904 can be affixed or coupled to at least one of a workpiece or a fixture securing the workpiece. By way of example and not limitation, a fixture secures the workpiece from movement during the first weld or the second weld. For instance, a fixture can be a clamp, a temporary weld (e.g., a tack weld), among others. It is to be appreciated that the wireless data received can be used by welding job sequencer component 302 to control use of at least one of welding job sequencer component 302 and/or welding sequence(s).

In an embodiment, the RFID component can be incorporated or affixed to an equipment, wherein the equipment can be, but not limited to, a helmet, a visor, a pair of glasses, a glove, a welding torch, an apron, a jacket, a welding sleeve of apparel, an identification badge of the operator, an earpiece, a pair of headphones, an ear plug, a headband, a bandana, a watch, an item of jewelry (e.g., ring, necklace, bracelet, among others), and the like. Thus, an operator can be within a distance to RFID tag 904 which would trigger wireless data communication between RFID tag 904 and RFID component 902 (incorporated or affixed to equipment used by the operator). This wireless data communication triggered can then be used to control use of a welding sequence, a portion of a welding sequence (e.g., a step of the welding sequence), welding job sequencer component 302, and/or a combination thereof.

In another embodiment, the wireless data communicated can initiate at least one of a weld score component (not shown but discussed above in FIG. 3) or a check point component (not shown but discussed in FIG. 3). In still another embodiment, the wireless data communicated from RFID tag 904 can indicate a collection of data to begin or stop, wherein the collection of data can relate to video, image, sound, audio, welding equipment settings, among others. For example, data related to a welding procedure or data used to train how to perform a welding procedure can be captured upon receipt of wireless data from RFID tag 904. Thus, the wireless data communicated can trigger a capture of data that can be used for weld creation training, assembly instructions, among others.

In another example, RFID component 902 can include an “on” and “off” switch which can be used to activate (e.g., receive wireless data) or not receive RFID wireless data. Based on such configuration, RFID tag 904 and RFID component 902 can be used as a switch to begin or stop a particular control or command for welding job sequencer component 302. In the above example, when the operator is within a distance to receive RFID tag data, the operator can turn “on” the reader (e.g., RFID component 902) to collect wireless data and initiate a data collection for a training, simulation, documentation, among others.

RFID tag 904 can be an active tag (e.g., power source used to allow transmission from tag to reader) or a passive tag (e.g., a portion of a signal received from RFID reader or component 902 is used to power transmission from the tag to RFID reader or component 902). Moreover, it is to be appreciated that there can be any suitable number of RFID readers, corresponding sets of tags for each reader, and the like. RFID reader or component 902 communicates wirelessly with at least one RFID tag 904 based on a geographic range or distance therebetween. For instance, based on at least one of a frequency, power source (e.g., passive tag, active tag, amount of power from power source), among others, the geographic range or distance can vary. In any event, when the frequency and/or power source allow wireless communication between at least one tag and RFID reader or component 902, data is communicated from at least one RFID tag to RFID reader or component 902, wherein the data communicated facilitates controlling a welding procedure during performance of a weld by an operator that is using a welding sequence.

An RFID system (e.g., system 900) consists of at least an RFID tag (e.g., RFID tag 904) and an RFID transceiver (e.g., RFID component 902). The RFID tag can contain an antenna that provides reception and/or transmission to radio frequency queries from the RFID transceiver. The RFID tag can be a small object, such as, for example, an adhesive sticker, a flexible label and integrated chip, etc. There are typically four different frequencies the RFID tags utilize: low frequency tags (between about 125 to 134 kilohertz), high frequency tags (about 13.56 megahertz), UHF tags (about 868 to 956 megahertz) and Microwave tags (about 2.45 gigahertz). In general, an RFID system can include multiple components: tags, tag readers (e.g., tag transceivers), tag writers, tag-programming stations, circulation readers, sorting equipment, tag inventory wands, among others.

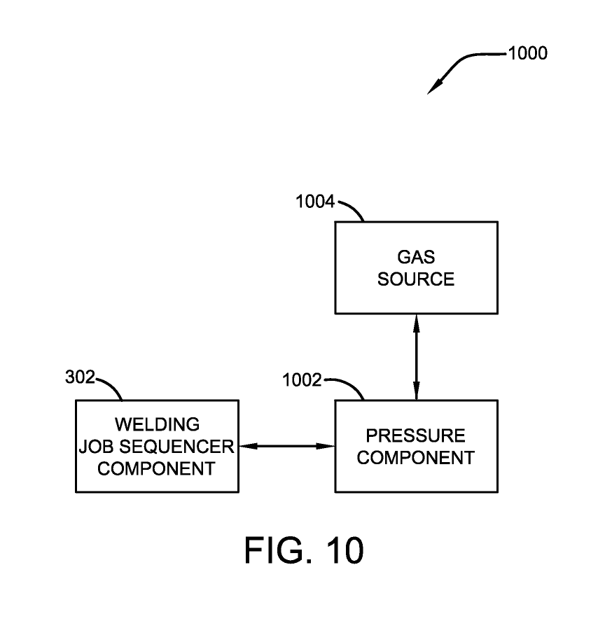

FIG. 10 illustrates system 1000 that manages a welding sequence used for performing a weld. System 1000 includes pressure component 1002 that is configured to detect real time pressure levels for a gas source 1004 used with a welding operation. In particular, gas source 1004 is used with a welding operation that is performed by an operator and guided by a welding sequence via welding job sequencer component 302. Pressure component 1002 monitors gas source 1004 to detect pressure levels that indicate a level that degrades a quality for a weld. For instance, a low pressure level can be a reading for gas source 1004 that requires replenishment in order to maintain a quality of weld. Thus, pressure component 1002 can monitor gas source 1004 and manage welding job sequencer component 302 and/or a welding sequence accordingly.

In an embodiment, pressure component 1002 detects the low pressure level and halts the creation of a weld. For instance, welding equipment can be powered down, an indicator can be communicated to the operator, among others. Upon a halting of the welding procedure due to a low pressure level being detected, a signal can be communicated to replenish gas source 1004 above the low pressure level. For instance, a maintenance department or the operator can be notified to replenish gas source 1004. Once gas source 1004 is replenished, the operator can continue with the welding procedure where he or she left off. In other words, pressure component 1002 provides seamless stopping and starting for a welding operation using a welding sequence based on a detected gas source 1004 pressure level in order to maintain a quality weld. It is to be appreciated that welding job sequencer 302 can leverage other real time monitoring techniques (discussed above in FIG. 7) in order to provide seamless stopping and/or starting based on the real time monitoring. For instance, maintenance, repair, replenishing consumables, pre-shift routines, among others can be monitored in real time and be a basis for seamless stopping and/or starting.

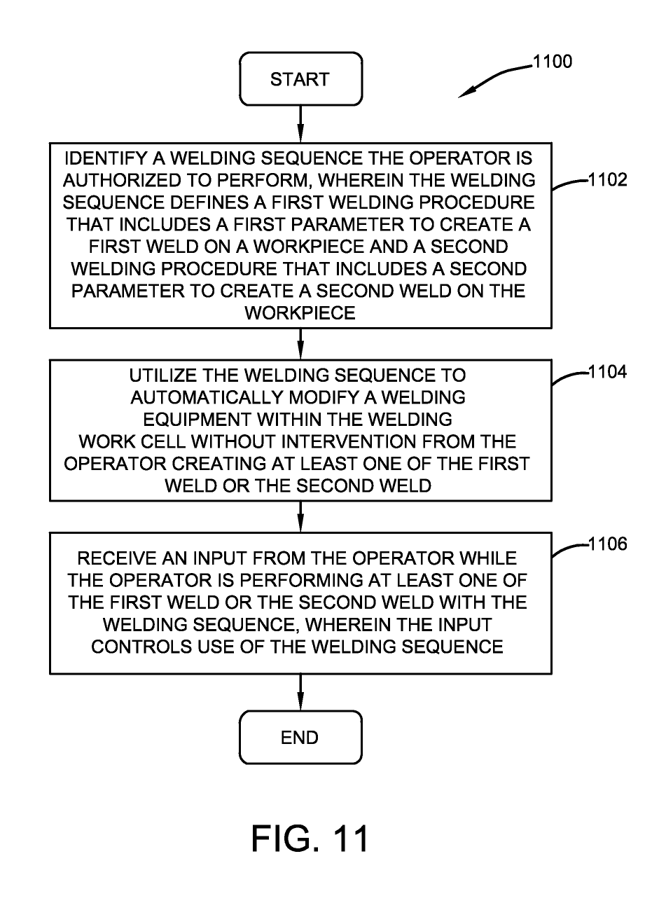

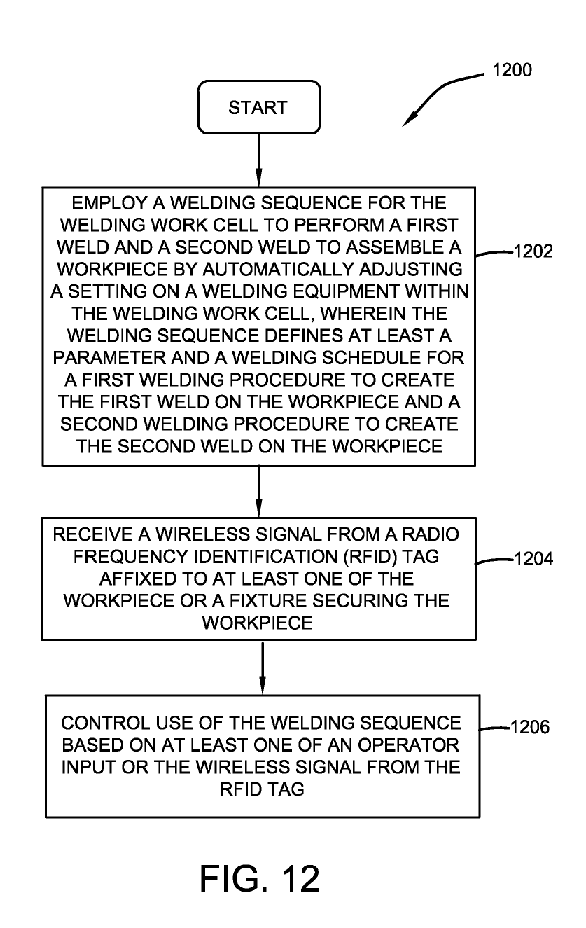

In view of the exemplary devices and elements described supra, methodologies that may be implemented in accordance with the disclosed subject matter will be better appreciated with reference to the flow charts and/or methodologies of FIGS. 11 and 12. The methodologies and/or flow diagrams are shown and described as a series of blocks, the claimed subject matter is not limited by the order of the blocks, as some blocks may occur in different orders and/or concurrently with other blocks from what is depicted and described herein. In an embodiment, a first input can be received prior to a second input (as described below). In another embodiment, a second input can be received prior to a first input. In an embodiment, the a first input and a second input can be received at substantially the same time. Moreover, not all illustrated blocks may be required to implement the methods and/or flow diagrams described hereinafter.

Sequentially, the following occurs as illustrated in the decision tree flow diagram 1100 of FIG. 11 which is a flow diagram 1100 that controls a welding operation that uses a welding sequence in real time. Methodology 1100 facilitates employing a welding sequence during a welding operation for a workpiece. A welding sequence is identified for an operator to use in a welding work cell, wherein the welding sequence defines a first welding procedure that includes a first parameter to create a first weld on a workpiece and a second welding procedure that includes a second parameter to create a second weld on the workpiece (reference block 1102). The welding sequence is utilized to automatically modify a welding equipment within the welding work cell without intervention from the operator creating at least one of the first weld or the second weld (reference block 1104). An input from the operator is received while the operator is performing at least one of the first weld or the second weld with the welding sequence, wherein the input controls use of the welding sequence (reference block 1106).

The following occurs as illustrated in the flow diagram 1200 of FIG. 12. Flow diagram 1200 relates to utilizing a wireless signal to control one or more welding procedures that use a welding sequence. A welding sequence for the welding work cell is employed to perform a first weld and a second weld to assemble a workpiece by automatically adjusting a setting on a welding equipment within the welding work cell, wherein the welding sequence defines at least a parameter and a welding schedule for a first welding procedure to create the first weld on the workpiece and a second welding procedure to create the second weld on the workpiece (reference block 1202). A wireless signal is received from a radio frequency identification (RFID) tag affixed to at least one of the workpiece or a fixture securing the workpiece (reference block 1204). Use of the welding sequence is controlled based on at least one of an operator input or the wireless signal from the RFID tag (reference block 1206).

In an embodiment, a method can include at least the steps of receiving a wireless signal from a Radio Frequency Identification (RFID) tag affixed to at least one of the workpiece or a fixture securing the workpiece and controlling the use of the welding sequence based upon the wireless signal from the RFID tag. In an embodiment, a method can include at least the steps of performing at least one of the first weld or the second weld with a gas source; monitoring a pressure level for the gas source; restricting performance of at least one of the first weld or the second weld based on the pressure level dropping below a low pressure level; and communicating a refill request for the gas source to place the pressure level above the low pressure level. In an embodiment, a method can include at least the steps of refilling the gas source to a pressure level above the low pressure level; and removing the restricted performance of at least one of the first weld or the second weld based on a refill of the gas source to place the pressure level above the low pressure level.

By way of example and not limitation, welding equipment (e.g., controller for a welder power source, wire feeder, welder power source, among others) can include one or more steps related to a particular welding process for a specific workpiece, wherein a step can include a respective setting or configuration for at least one welding equipment. For instance, a first workpiece can include steps A, B, C, and D based on welding parameters desired, the welding process used, and/or the workpiece. In another example, a second workpiece can include steps B, C, A, E, and F. With the employment of a welding sequence, the controller implementing the steps for the welding process via the welder power source and/or welding equipment can be managed and/or instructed. For instance, the welding sequence can indicate at least one of the following: which steps to perform, redo a step, skip a step, pause a sequence of steps, among others. Furthermore, a controller (e.g., or other suitable component) can control one or more welder power sources, parameters, welding schedules, among others associated with one or more welding processes, wherein each welding process can have a corresponding welding sequence(s).

In an embodiment, a system can include a weld score component that is configured to evaluate at least one of the first weld or the second weld performed on the workpiece by the operator based upon at least one of an image of the first weld or the second weld or a user inspection. In an embodiment, a system can include a check point component that is configured to monitor the identified operator and creation of at least one of the first weld or the second weld in real time. In an embodiment, the welding job sequencer component further instructs an operator of the welding work cell to assemble the workpiece with the first welding procedure and the second welding procedure having two separate welding schedules.

In an embodiment, a system can include an equipment of the operator that incorporates the input component, wherein the operator interacts with the equipment to provide the input. In an embodiment, the equipment of the operator is at least one of a helmet, a visor, a pair of glasses, a glove, an apron, a jacket, a welding sleeve, an identification badge of the operator, an earpiece, a pair of headphones, or an ear plug. In an embodiment, the input component includes at least one button to receive the input from the operator. In an embodiment, the input component includes at least one of a display to communicate data related to the welding job sequencer component or a touchscreen to interact with the welding job sequencer component. In an embodiment, the input component includes a component to vibrate based on a signal received via the welding job sequencer component.

In an embodiment, a system can include a portable device that incorporates the input component, wherein the operator interacts with the portable device to provide the input. In an embodiment, the portable device is at least one of a motion sensor device, a wireless fidelity (WiFi) device, a tablet, a touchscreen, an accelerometer device, a gaming device, a smartphone, or a voice recognition device.

In an embodiment, a system can include a Radio Frequency Identification (RFID) tag affixed to at least one of the workpiece or a fixture maintaining a physical location of the workpiece and a Radio Frequency Identification (RFID) component that is configured to receive a wireless signal from the RFID tag based upon the RFID tag being within a distance from the RFID component, wherein the wireless signal includes a portion of data, wherein the welding job sequencer component is further configured to utilize the portion of data as the input. In an embodiment, the system can include an equipment of the operator that incorporates the RFID component, wherein the equipment of the operator is at least one of a helmet, a visor, a pair of glasses, a glove, an apron, a jacket, a welding sleeve, an identification badge of the operator, an earpiece, a pair of headphones, a welding torch, or an ear plug.

In an embodiment, the system can include a pressure component that is configured to monitor a pressure level for a gas source used with performing at least one of the first weld or the second weld and the welding job sequencer component is further configured to halt at least one of the first weld or the second weld based on the pressure level dropping below a low pressure level, wherein the welding job sequencer component removes halting of at least one of the first weld or the second weld based on a refill of the gas source to place the pressure level above the low pressure level.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A welder system, comprising:
a welding job sequencer component that is configured to identify a welding sequence for a welding work cell, wherein the welding sequence defines at least a parameter and a welding schedule for a first welding procedure to create a first weld on a workpiece and a second welding procedure to create a second weld on the workpiece;
the welding job sequencer component is further configured to utilize the welding sequence in the welding work cell to automatically configure welding equipment to perform the first welding procedure and the second welding procedure on the workpiece without intervention from the operator;
an input component that is configured to receive an input from the operator while the operator is performing at least one of the first weld or the second weld, wherein the input controls at least one of the utilization of the welding sequence or the welding job sequencer component.

2. The welder system of claim 1, further comprising a weld score component that is configured to evaluate at least one of the first weld or the second weld performed on the workpiece by the operator based upon at least one of an image of the first weld or the second weld or a user inspection.

3. The welder system of claim 1, further comprising a check point component that is configured to monitor the identified operator and creation of at least one of the first weld or the second weld in real time.

4. The welder system of claim 1, wherein the welding job sequencer component further instructs an operator of the welding work cell to assemble the workpiece with the first welding procedure and the second welding procedure having two separate welding schedules.

5. The welder system of claim 1, further comprising an equipment of the operator that incorporates the input component, wherein the operator interacts with the equipment to provide the input.

6. The welder system of claim 5, wherein the equipment of the operator is at least one of a helmet, a visor, a pair of glasses, a glove, an apron, a jacket, a welding sleeve, an identification badge of the operator, an earpiece, a pair of headphones, or an ear plug.

7. The welder system of claim 5, wherein the input component includes at least one button to receive the input from the operator.

8. The welder system of claim 5, wherein the input component includes at least one of a display to communicate data related to the welding job sequencer component or a touchscreen to interact with the welding job sequencer component.

9. The welder system of claim 5, wherein the input component includes a component to vibrate based on a signal received via the welding job sequencer component.

11. The welder system of claim 1, further comprising a portable device that incorporates the input component, wherein the operator interacts with the portable device to provide the input.

12. The welder system of claim 11, wherein the portable device is at least one of a motion sensor device, a wireless fidelity (WiFi) device, a tablet, a touchscreen, an accelerometer device, a smartphone, a gaming device, or a voice recognition device.

13. The welder system of claim 1, further comprising:
a Radio Frequency Identification (RFID) tag affixed to at least one of the workpiece or a fixture maintaining a physical location of the workpiece;
a Radio Frequency Identification (RFID) component that is configured to receive a wireless signal from the RFID tag based upon the RFID tag being within a distance from the RFID component, wherein the wireless signal includes a portion of data; and
the welding job sequencer component is further configured to utilize the portion of data as the input.

14. The welder system of claim 13, further comprising an equipment of the operator that incorporates the RFID component, wherein the equipment of the operator is at least one of a helmet, a visor, a pair of glasses, a glove, an apron, a jacket, a welding sleeve, an identification badge of the operator, an earpiece, a pair of headphones, a welding torch, or an ear plug.

15. The welder system of claim 1, further comprising:
a pressure component that is configured to monitor a pressure level for a gas source used with performing at least one of the first weld or the second weld;
the welding job sequencer component is further configured to halt at least one of the first weld or the second weld based on the pressure level dropping below a low pressure level; and
wherein the welding job sequencer component removes halting of at least one of the first weld or the second weld based on a refill of the gas source to place the pressure level above the low pressure level.

16. A method of welding in a welding work cell, comprising:
identifying a welding sequence for an operator to use in a welding work cell, wherein the welding sequence defines a first welding procedure that includes a first parameter to create a first weld on a workpiece and a second welding procedure that includes a second parameter to create a second weld on the workpiece;
utilizing the welding sequence to automatically modify a welding equipment within the welding work cell without intervention from the operator creating at least one of the first weld or the second weld; and
receiving an input from the operator while the operator is performing at least one of the first weld or the second weld with the welding sequence, wherein the input controls use of the welding sequence.

17. The method of claim 16, further comprising:
receiving a wireless signal from a Radio Frequency Identification (RFID) tag affixed to at least one of the workpiece or a fixture securing the workpiece; and
controlling the use of the welding sequence based upon the wireless signal from the RFID tag.

18. The method of claim 16, further comprising:
performing at least one of the first weld or the second weld with a gas source;
monitoring a pressure level for the gas source; and
restricting performance of at least one of the first weld or the second weld based on the pressure level dropping below a low pressure level; and
communicating a refill request for the gas source to place the pressure level above the low pressure level.

19. The method of claim 18, further comprising:
refilling the gas source to a pressure level above the low pressure level; and
removing the restricted performance of at least one of the first weld or the second weld based on a refill of the gas source to place the pressure level above the low pressure level.

20. A welder system, comprising:
means for identifying a welding sequence for an operator to use in a welding work cell, wherein the welding sequence defines a first welding procedure that includes a first parameter to create a first weld on a workpiece and a second welding procedure that includes a second parameter to create a second weld on the workpiece;
means for utilizing the welding sequence to automatically modify a welding equipment within the welding work cell without intervention from the operator creating at least one of the first weld or the second weld;
means for receiving an input from the operator while the operator is performing at least one of the first weld or the second weld;
means for receiving a wireless signal from a Radio Frequency Identification (RFID) tag affixed to at least one of the workpiece or a fixture securing the workpiece; and
means for controlling use of the welding sequence based on at least one of the wireless signal from the RFID tag or the input.
